(19) United States
(12) Patent Application Publication
(10) Pub. No.: US 2024/0070441 A1
(43) Pub. Date: Feb. 29, 2024

(54) RECONFIGURABLE ARCHITECTURE FOR FUSED DEPTH-WISE SEPARABLE CONVOLUTION (DSC)

(71) Applicant: QUALCOMM Incorporated, San Diego, CA (US)

(72) Inventors: Zichao YUE, San Diego, CA (US); Sean Patrick Claye FOX, San Diego, CA (US); Janarbek MATAI, San Diego, CA (US); Kristopher URQUHART, Poway, CA (US)

(21) Appl. No.: 18/451,726

(22) Filed: Aug. 17, 2023

Related U.S. Application Data
(60) Provisional application No. 63/402,377, filed on Aug. 30, 2022.

(51) Int. Cl. G06N 3/0464; G06N 3/10

(52) U.S. Cl. CPC G06N 3/0464; G06N 3/10

(57) ABSTRACT

A method of operating a depth-wise separable convolutional (DSC) network on a DSC accelerator includes determining a difference between a first throughput associated with a depth-wise convolution (DWC) engine of the DSC accelerator and a second throughput associated with a point-wise convolution (PWC) engine of the DSC accelerator. The method also includes selectively activating, for each layer of the DSC network, each first processing elements (PEs) in one or more of a first set of columns of first PEs associated with the DWC engine and/or each second PE in one or more of a second set of columns associated with the PWC engine based on the difference between the first throughput and the second throughput. The method further includes processing, for each layer of the DSC network, an input via the DSC accelerator based on selectively activating each first PE and/or each second PE.

### CROSS-REFERENCE TO RELATED APPLICATION

The present application claims the benefit of U.S. Provisional Patent Application No. 63/402,377, filed on Aug. 30, 2022, and titled “RECONFIGURABLE ARCHITECTURE FOR FUSED DEPTH-WISE SEPARABLE CONVOLUTION (DSC),” the disclosure of which is expressly incorporated by reference in its entirety.

### FIELD OF THE DISCLOSURE

Aspects of the present disclosure generally relate to a reconfigurable architecture for a depth-wise separable convolution (DSC) model.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

In some neural networks, one or more depth-wise separable convolution (DSC) layers may be used to reduce a size of a convolutional neural network (CNN) while still satisfying one or more accuracy conditions for the CNN. Each DSC layer may include one or more depth-wise convolution (DWC) layers and one or more point-wise convolution (PWC) layers. The DWC layers may perform individual convolutions on each input channel to minimize a parameter size. The PWC layers may combine resulting feature maps to generate a compressed representation.

### SUMMARY

In one aspect of the present disclosure, a method for operating a depth-wise separable convolutional (DSC) network on a DSC accelerator includes determining, at a first time, a difference between a first throughput associated with a DWC engine of the DSC accelerator and a second throughput associated with a PWC engine of the DSC accelerator. The method also includes selectively activating, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput. The method further includes processing, at a third time for each layer of the DSC network, an input via the DSC accelerator based on selectively activating each first PE in the one or more first columns and/or each second PE in the one or more second columns.

Another aspect of the present disclosure is directed to an apparatus including means for determining, at a first time, a difference between a first throughput associated with a DWC engine of the DSC accelerator and a second throughput associated with a PWC engine of the DSC accelerator. The apparatus also includes means for selectively activating, at a second time for each layer of the DSC network, each first PEs in one or more first columns of a first set of columns of first PEs associated with the DWC engine and/or each second PE in one or more second columns of a second set of columns associated with the PWC engine based on the difference between the first throughput and the second throughput. The apparatus further includes means for processing, at a third time for each layer of the DSC network, an input via the DSC accelerator based on selectively activating each first PE in the one or more first columns and/or each second PE in the one or more second columns.

In another aspect of the present disclosure, a non-transitory computer-readable medium with non-transitory program code recorded thereon is disclosed. The program code is executed by a processor and includes program code to determine, at a first time, a difference between a first throughput associated with a DWC engine of the DSC accelerator and a second throughput associated with a PWC engine of the DSC accelerator. The program code also includes program code to selectively activate, at a second time for each layer of the DSC network, each first PEs in one or more first columns of a first set of columns of first PEs associated with the DWC engine and/or each second PE in one or more second columns of a second set of columns associated with the PWC engine based on the difference between the first throughput and the second throughput. The program code further includes program code to process, at a third time for each layer of the DSC network, an input via the DSC accelerator based on selectively activating each first PE in the one or more first columns and/or each second PE in the one or more second columns.

Another aspect of the present disclosure is directed to an apparatus having one or more processors; and one or more memories coupled with the one or more processors and storing instructions operable, when executed by the one or more processors, to cause the apparatus to determine, at a first time, a difference between a first throughput associated with a DWC engine of the DSC accelerator and a second throughput associated with a PWC engine of the DSC accelerator. Execution of the instructions also cause the apparatus to selectively activate, at a second time for each layer of the DSC network, each first PEs in one or more first columns of a first set of columns of first PEs associated with the DWC engine and/or each second PE in one or more second columns of a second set of columns associated with the PWC engine based on the difference between the first throughput and the second throughput. Execution of the instructions further cause the apparatus process, at a third time for each layer of the DSC network, an input via the DSC accelerator based on selectively activating each first PE in the one or more first columns and/or each second PE in the one or more second columns.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an example of a depth-wise separable convolution (DSC) accelerator, in accordance with various aspects of the present disclosure.

FIG. 5 is a block diagram illustrating an example of a DSC accelerator, in accordance with various aspects of the present disclosure.

FIG. 6 is a flow diagram illustrating an example process performed by a DSC accelerator, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures, and in the following description of the preferred aspects. The detailed description and drawings are merely illustrative of the disclosure rather than limiting, the scope of the disclosure being defined by the appended claims and equivalents thereof.

In some neural networks, one or more depth-wise separable convolution (DSC) layers may be used to reduce a size of a convolutional neural network (CNN) while still satisfying one or more accuracy conditions for the CNN. Each DSC layer may include one or more depth-wise convolution (DWC) layers and one or more point-wise convolution (PWC) layers. The DWC layers may perform individual convolutions on each input channel, minimizing a parameter size, while the PWC layers combine resulting feature maps, creating a compressed representation.

In the DWC layers, a number of filters may equal a number of input channels. Each filter may operate exclusively on one channel. In some examples, if the input feature map has N channels with a kernel size K, for a convolution operation, the filter size may be reduced from K²*N*M to K²*N, where M represents a total number of output channels. In such examples, a number of compute operations may be reduced. The PWC layers may use a kernel size of 1×1 for convolution operations.

In comparison to conventional convolution layers, the DWC layers may have fewer data reuse opportunities. Directly mapping the DWC layers to accelerators designed for the conventional convolution layers reduce an amount of resources used by a neural network, such as the CNN, and/or decrease hardware throughput. Furthermore, the DWC layers may be memory-bound, whereas the conventional convolution layers and the PWC layers may be compute-bound. This distinction in performance characteristics underscores specific considerations and potential challenges involved in integrating DWC layers into hardware accelerators or optimizing DWC layers within a CNN.

In some cases, to improve hardware throughput and reduce resource use, conventional DSC layers may use domain specific accelerators. In some conventional systems, a single compute engine may be designated for both the DWC layers and the PWC layers, thereby offering increased flexibility for the accelerator. Nevertheless, this approach may also increase a complexity of a data path. In some other conventional DSC accelerators, discrete engines may be specified for the DWC layers and the PWC layers. Such conventional systems may increase throughput by reducing data path complexity and incorporating inter-layer pipelining. However, the mismatch in throughput between the DWC layers and the PWC layers may result in an unbalanced inter-layer pipeline, which may reduce the overall performance of the DSC accelerators. The DWC layers may be referred to as a DWC engine, and the PWC layers may be referred to as a PWC engine.

Various aspects of the present disclosure are directed to using run-time reconfigurable processing elements (PEs) in a discrete DWC engine and PWC engine of a DSC accelerator. The PEs may be configured as PWC PEs or DWC PEs.

Additionally, a number of active columns of PEs in each engine may be selectively activated at run-time, for each layer. By selectively activating the number of active columns of PEs, the discrete engines may be adaptable to different CNN models, improving throughput matching between the PWC engine and the DWC engine. In some examples, an accelerator with the PEs may be configured for conventional convolution layers or only PWC layers.

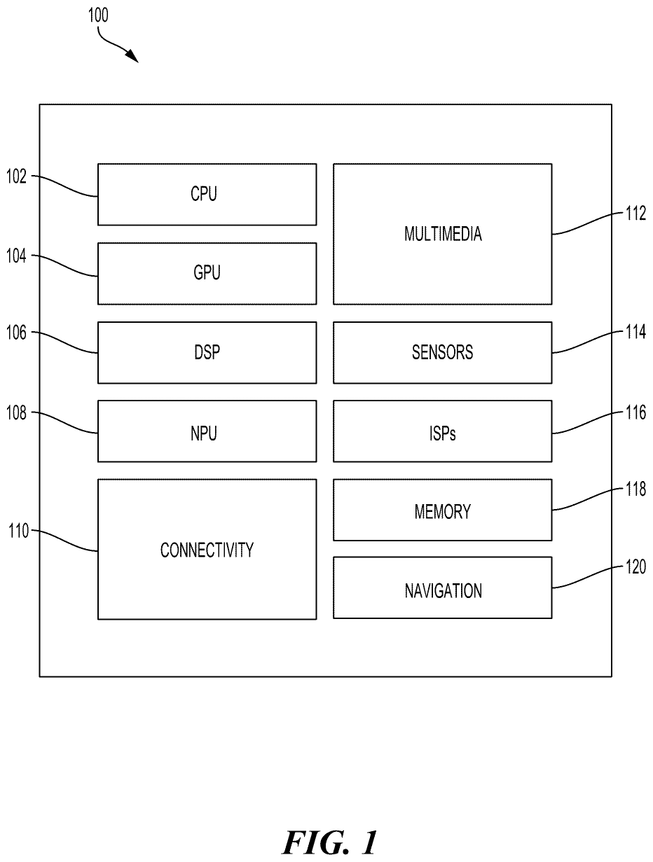

FIG. 1 illustrates an example implementation of a system-on-a-chip (SOC) 100, which may include a central processing unit (CPU) 102 or a multi-core CPU configured for using run-time reconfigurable processing elements (PEs). Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

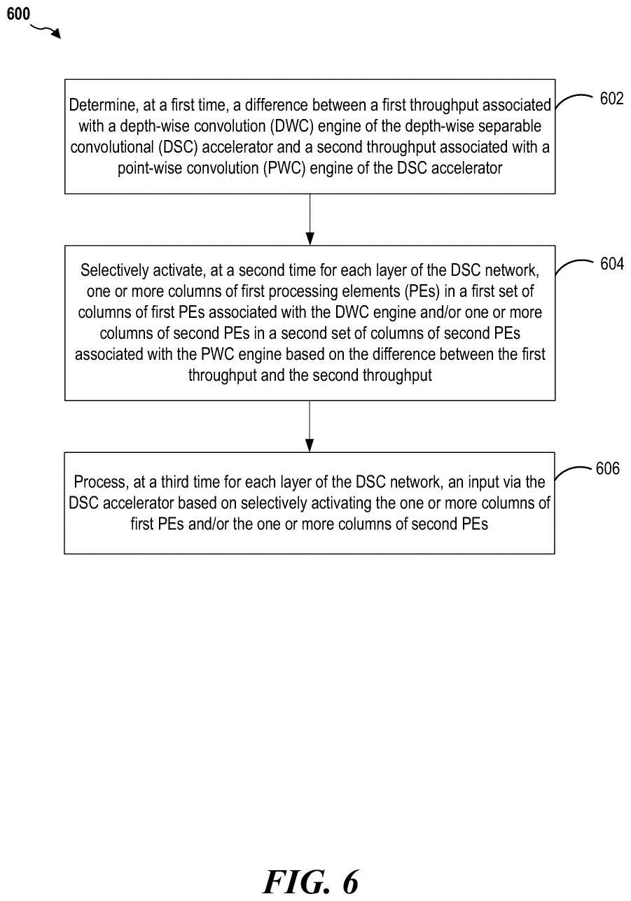

The SOC 100 may be based on an ARM instruction set or any instruction set architecture (ISA). In an aspect of the present disclosure, the instructions loaded into the general-purpose processor 102 may include code to perform one or more of the steps of the process 600 described with reference to FIG. 6.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

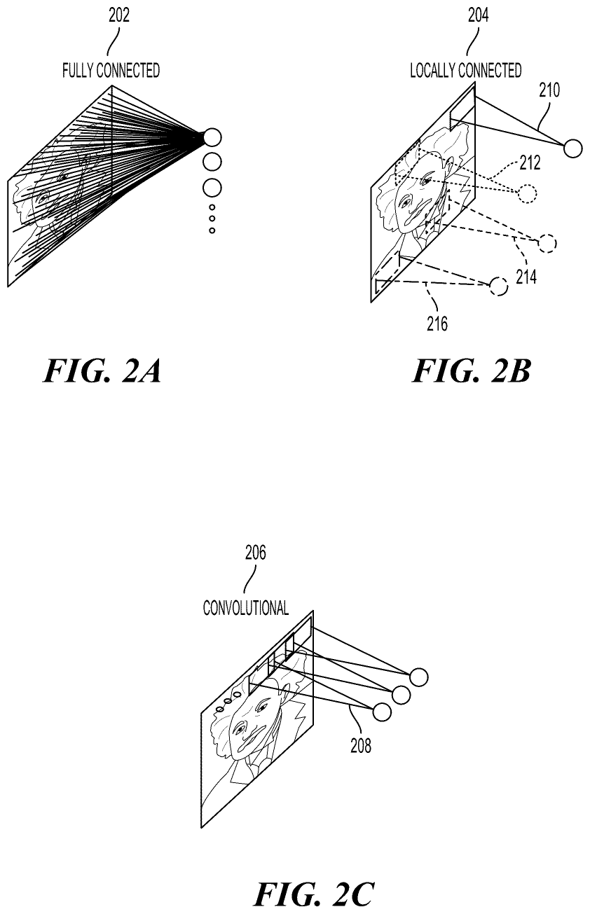

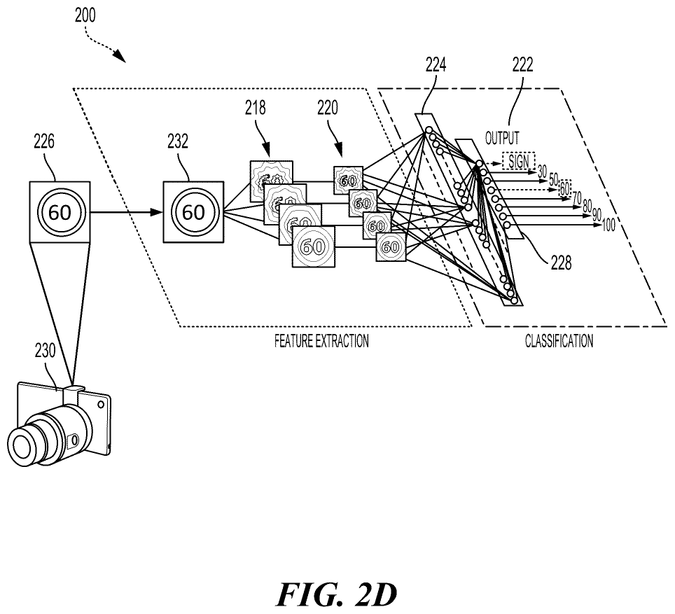

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

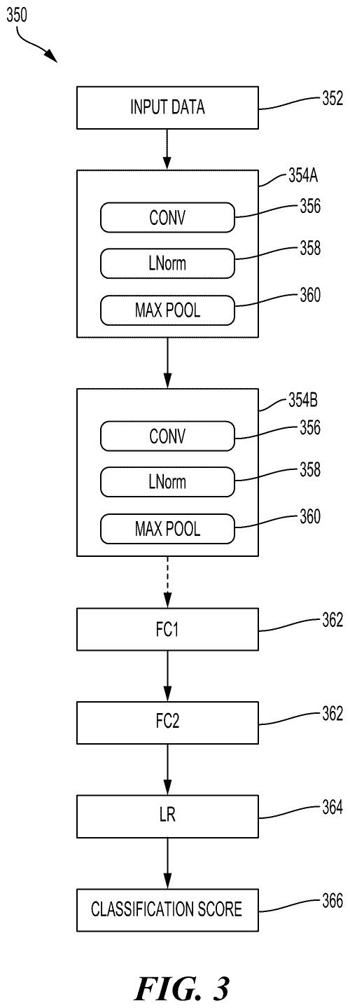

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

As discussed, various aspects of the present disclosure are directed to using a group of run-time reconfigurable processing elements (PEs) in a DWC engine and a PWC engine associated with a DSC layer. In some examples, at a compile time, a difference between the throughput of the DWC engine and the PWC engine of the DSC is determined. Subsequently, at run-time, or prior to run-time, for each layer of the DSC network, first PEs in one or more columns associated with the DWC engine and/or second PEs in one or more columns associated with the PWC engine are selectively activated based on the throughput difference. Finally, at run-time, at each layer of the DSC network, the input may be processed through the DSC accelerator by the selectively activated first PEs and/or second PEs.

The first PEs may be dual functional (DF) PEs, while the second PEs can be either DF PEs or PWC PEs. The DWC engine includes multiple window buffers that read input feature maps from the respective input channels, and each window buffer outputs to one or more first PEs associated with different columns. The activation of the columns of first PEs and/or second PEs may be based on various factors, such as the kernel size, number of output channels, delay compensation in the DWC engine, and/or delay compensation in the PWC engine.

As discussed, the DWC engine and/or the PWC engine may include one or more respective columns of PEs. Additionally, a number of active columns of PEs may be selectively activated at run-time. By selectively activating the number of active columns of PEs, the discrete engines (e.g., the DWC engine and PWC engine) may adapt to different CNN models, thereby improving throughput matching between the PWC engine and the DWC engine. Additionally, in some instances, an accelerator equipped with the group of PEs may be configured for conventional convolution layers or exclusively for PWC layers, offering further adaptability and optimization possibilities.

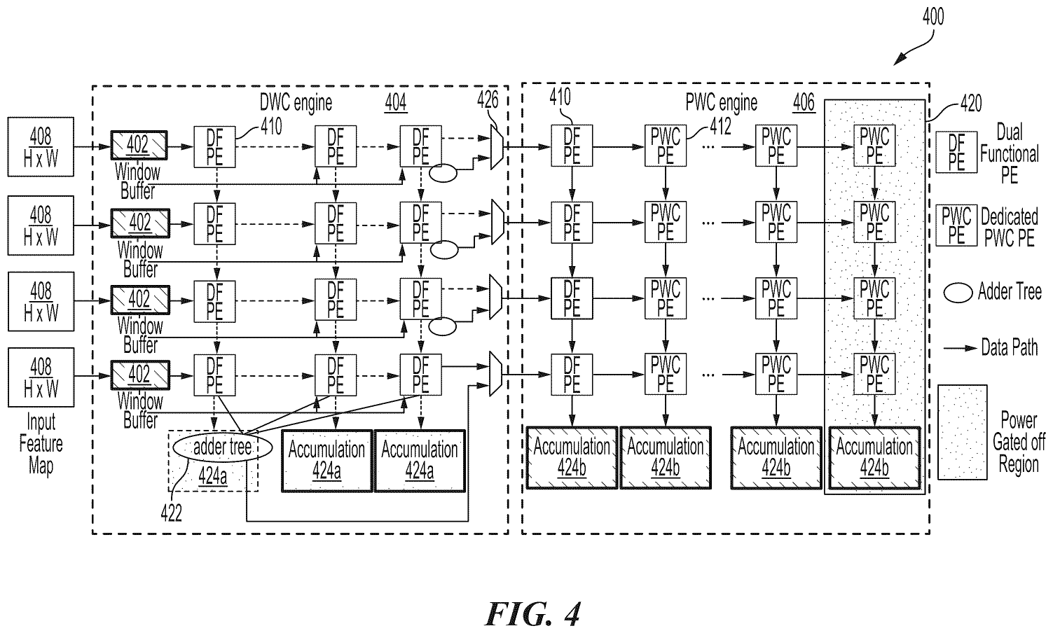

FIG. 4 is a block diagram illustrating an example of a DSC accelerator 400, in accordance with various aspects of the present disclosure. In the example of FIG. 4, the DSC accelerator 400 may use a PE array-based architecture that includes window buffers 402, a DWC engine 404, and a PWC engine 406. Each window buffer 402 may read input feature maps 408 from a corresponding input buffer (not shown in FIG. 4) and prepare data streams to feed into later stages, such as dual function (DF) PEs 410 of the DWC engine 404. For ease of explanation, only one DF PE 410 is labeled in the DWC engine 404. Each window buffer 402 processes one input channel and can provide up to N data elements in a single cycle.

FIG. 4 shows an example of a power gated off region 420 associated with a final PWC PE column. Aspects of the present disclosure are not limited to the power gated off region 420 being associated with the final PWC PE column. In some examples, two or more PE columns may be active, and the non-active PE columns may be gated off (e.g., turned off).

In the example of FIG. 4, a shift-register-based structure (not shown in the example of FIG. 4) may be used to send different numbers of elements simultaneously at run-time. The DSC accelerator 400 may use DF PEs 410 and/or PWC PEs 412. In the example of FIG. 4, the DWC engine 404 may only use DF PEs 410, and the PWC engine 406 may use both DF PEs 410 and PWC PEs 412. For ease of explanation, only one DF PE 410 and one PWC PE 412 is labeled in the PWC engine 406. In some examples, within each one of the DWC engine 404 and the PWC engine 406, a number of active columns of PEs 410 and 412 may be selectively activated at run-time. The DF PEs 410 may be used in the DWC engine 404 and/or the PWC engine 406. Additionally, the PWC PEs 412 may only be used in the PWC engine 406. The number of DF PEs 410 used in the DWC engine 404 and the PWC engine 406 can be configured at run-time via instructions, which renders the DSC accelerator 400 run-time reconfigurable. A maximum number of PE columns in the DWC engine 404 is N, which also represents a maximum number of elements a window buffer 402 can extract in a single cycle. In some examples, a number of PEs allocated to the PWC engine 406 may be greater than the number of PEs allocated to the DWC engine 404 because the PWC engine 406 may be compute-bound. The PWC PEs 412 may be less complex than DF PEs 410. Additionally, one or more columns of PWC PEs 412 may be power gated off at run-time.

As shown in the example of FIG. 4, each column may be associated with an accumulation block 424a or 424b. Each accumulation block 424a or 424b may include a buffer for storing intermediate PWC results. In the example of FIG. 4, a first set of accumulation blocks 424a associated with the DWC engine 404 may be power gated off. A second set of accumulation blocks 424b, associated with the PWC engine 406 may be active. When a number of input channels is greater than a number of rows of PEs 410 and 412 (e.g., a PE array), input data may be partitioned into smaller batches, each batch containing a same number of input channels as the rows of the PE array. In this case, an output of the PWC engine 406 may be referred to as intermediate results, and a final result may be the accumulation of the intermediate results. During the accumulation process, each of the second set of accumulation blocks 424b, working in conjunction with one or more PWC PEs 412 in a respective column, may retrieve the intermediate results from a respective buffer associated with the accumulation block 424b. The respective intermediate results may then be added to the computation results of the current batch, and then written to the updated intermediate results back to the buffer in the accumulation blocks 424. This approach effectively reduces off-chip memory traffic, as the accumulation blocks 424 serve to minimize the need for data transfers to external memory.

As shown in the example of FIG. 4, an adder tree 422 may be specified for each row of DF PEs 410 in the DWC engine 404 to sum partial results received from DF PEs 410 in a same row. For ease of explanation, the example of FIG. 4 only shows one adder tree 422 connected to a bottom row of DF PEs 410. The summed partial results may be multiplexed, at a multiplexer 426, with an output of a final DF PE 410 in a corresponding row to generate an input to the PWC engine 406. In some examples, a one-dimensional (1D) systolic array may be used instead of the adder tree 422.

In comparison to conventional discrete engine designs, the DSC accelerator 400 architecture improves throughput matching between the DWC engine 404 and the PWC engine 406. Assuming each PWC PE 412 and DF PE 410 is associated with only one multiply-accumulate (MAC) unit, each PWC PE 412 may consume one input data every cycle. However, if the kernel size is K, one DF PE 410 may use K² cycles to produce one input data for the PWC engine 406. In some examples, one PWC PE 412 may use M cycles to consume one input data if M output channel weights are stored in the PWC PE 412.

The DSC accelerator 400 may also reduce energy consumption. In some examples, intermediate data may be directly transferred between the DWC engine 404 and the PWC engine 406 without any off-chip communication, which reduces energy caused by data movement. In some other examples, redundant PWC PEs 412 can be power gated off, which further saves energy. Furthermore, in some examples, the DSC accelerator 400 may be flexible for different neural network models. In some aspects, all PEs 410 and 412 may be used for a conventional convolution engine or a stand-alone PWC engine.

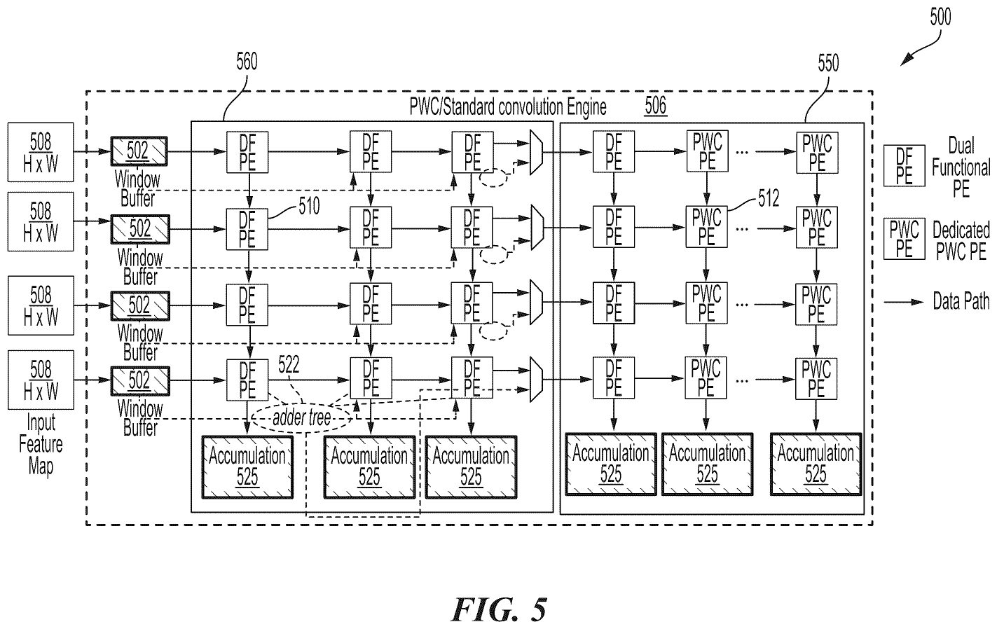

FIG. 5 is a block diagram illustrating an example of a DSC accelerator 500 for a PWC engine 506. The PWC engine 506 may be an example of a convolution engine. As shown in the example of FIG. 5, the DSC accelerator 500 may use a PE array-based architecture that includes a respective window buffer 502 for each row. Each window buffer 502 may read input feature maps 508 from a corresponding input buffer and prepare data streams to feed to later stages within the PWC engine 506. The DSC accelerator 500 may include one or more DF PEs 510 and one or more PWC PEs 512. For ease of explanation, only one PWC PE 512 and one DF PE 510 are labeled in the PWC engine 506.

As shown in the example of FIG. 5, an adder tree 522 may be power gated off. The data streams prepared by window buffer 502 may be fed from a first stage 560 of the PWC engine 506 to a second stage 550 of the PWC engine 506 via multiplexes after a final column of DF PEs 510 of the first stage 560 of the PWC engine 506.

As shown in the example of FIG. 5, each column may be associated with an accumulation block 525. Each accumulation block 525 may be a buffer for storing intermediate PWC results. When a number of input channels is greater than a number of rows of PEs (e.g., a PE array), input data may be partitioned into smaller batches, each batch containing a same number of input channels as the rows of the PE array. In this case, an output of PWC engine 506 may be referred to as intermediate results, and a final result may be the accumulation of the intermediate results. During the accumulation process, each accumulation block 525, working in conjunction with one or more PEs 512 in a respective column, retrieves the intermediate results from a buffer associated with the accumulation block 525, add them to the computation results of the current batch. The respective intermediate results may then be added to the computation results of the current batch, and then written to the updated intermediate results back to the buffer in the accumulation blocks 525. This approach effectively reduces off-chip memory traffic, as the accumulation blocks 525 serve to minimize the need for data transfers to external memory.

In various aspects of the present disclosure, some models may implement one DWC layer between two PWC layers. In these aspects, the DSC accelerator 500 may initially work in a PWC-only mode for the first PWC layer, and then work in a DSC mode (e.g., a dual engine DSC, such as the DSC accelerator 400 described with reference to FIG. 4) to process the subsequent DWC and PWC layers. The DSC accelerator 500 may also include an adder tree for each row of DF PEs 510.

In some examples, the DSC accelerators 400 and 500 described with reference to FIGS. 4 and 5, respectively, may fit different kernel sizes. For kernel sizes larger than N, the computation of one DWC output may be distributed into multiple cycles.

FIG. 6 is a flow diagram illustrating an example process 600 performed to run a DSC network on a DSC accelerator, in accordance with some aspects of the present disclosure. The DSC accelerator may be an example of the DSC accelerator 400 or 500 described with reference to FIGS. 4 and 5, respectively, or a DSC accelerator. The example process 600 is an example of selectively activating one or more first PEs and/or one or more second PEs. As shown in FIG. 6, the process 600 begins at block 602 by determining, at a first time, a difference between a first throughput associated with a depth-wise convolution (DWC) engine of the DSC accelerator and a second throughput associated with a point-wise convolution (PWC) engine of the DSC accelerator. At block 604, the process 600 selectively activates, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput. At block 606, the process 600 processes, at a third time for each layer of the DSC network, an input via the DSC accelerator based on selectively activating each first PE in the one or more first columns and/or each second PE in the one or more second columns.

Implementation examples are described in the following numbered clauses:
Clause 1. A method of operating a depth-wise separable convolutional (DSC) network on a DSC accelerator, comprising: determining, at a first time, a difference between a first throughput associated with a depth-wise convolution (DWC) engine of the DSC accelerator and a second throughput associated with a point-wise convolution (PWC) engine of the DSC accelerator; selectively activating, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput; and processing, at a third time for each layer of the DSC network, an input via the DSC accelerator based on selectively activating each first PE in the one or more first columns and/or each second PE in the one or more second columns.
Clause 2. The method of Clause 1, in which the first time is a compile time and the third time is a run time.
Clause 3. The method of any one of Clauses 1-2, in which: each first PE is a dual functional (DF) PE; and each second PE is one of the DF PE or a PWC PE.
Clause 4. The method of any one of Clauses 1-3, in which: the DWC engine includes a plurality of window buffers; and each of the plurality of window buffers reads one or more input feature maps from a respective input channel of a plurality of input channels.
Clause 5. The method of Clause 4, in which: each window buffer outputs to one or more first PEs; and each of the one or more first PEs is associated with a different column of the first set of columns.
Clause 6. The method of any one of Clauses 1-5, in which the one or more columns of first PEs and/or the one or more columns of second PEs are selectively activated based on a kernel size, a number of output channels, a first delay compensation in the DWC engine, and/or a second delay compensation in the PWC engine.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method of operating a depth-wise separable convolutional (DSC) network on a DSC accelerator, comprising:
determining, at a first time, a difference between a first throughput associated with a depth-wise convolution (DWC) engine of the DSC accelerator and a second throughput associated with a point-wise convolution (PWC) engine of the DSC accelerator;
selectively activating, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput; and
processing, at a third time for each layer of the DSC network, an input via the DSC accelerator based on selectively activating each first PE in the one or more first columns and/or each second PE in the one or more second columns.

2. The method of claim 1, in which the first time is a compile time and the third time is a run time.

3. The method of claim 1, in which:
each first PE is a dual functional (DF) PE; and
each second PE is one of the DF PE or a PWC PE.

4. The method of claim 1, in which:
the DWC engine includes a plurality of window buffers; and
each of the plurality of window buffers reads one or more input feature maps from a respective input channel of a plurality of input channels.

5. The method of claim 4, in which:
each window buffer outputs to one or more first PEs; and
each of the one or more first PEs is associated with a different column of the first set of columns.

6. The method of claim 1, in which the one or more columns of first PEs and/or the one or more columns of second PEs are selectively activated based on a kernel size, a number of output channels, a first delay compensation in the DWC engine, and/or a second delay compensation in the PWC engine.

7. An apparatus for operating a depth-wise separable convolutional (DSC) network on a DSC accelerator, comprising:
one or more processors; and
one or more memories coupled with the one or more processors and storing instructions operable, when executed by the one or more processors, to cause the apparatus to:
determine, at a first time, a difference between a first throughput associated with a depth-wise convolution (DWC) engine of the DSC accelerator and a second throughput associated with a point-wise convolution (PWC) engine of the DSC accelerator;
selectively activate, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput; and
process, at a third time for each layer of the DSC network, an input via the DSC accelerator based on selectively activating each first PE in the one or more first columns and/or each second PE in the one or more second columns.

8. The apparatus of claim 7, in which the first time is a compile time and the third time is a run time.

9. The apparatus of claim 7, in which:
each first PE is a dual functional (DF) PE; and
each second PE is one of the DF PE or a PWC PE.

10. The apparatus of claim 7, in which:
the DWC engine includes a plurality of window buffers; and
each of the plurality of window buffers reads one or more input feature maps from a respective input channel of a plurality of input channels.

11. The apparatus of claim 10, in which:
each window buffer outputs to one or more first PEs; and
each of the one or more first PEs is associated with a different column of the first set of columns.

12. The apparatus of claim 7, in which the one or more columns of first PEs and/or the one or more columns of second PEs are selectively activated based on a kernel size, a number of output channels, a first delay compensation in the DWC engine, and/or a second delay compensation in the PWC engine.

13. A non-transitory computer-readable medium having program code recorded thereon for operating a depth-wise separable convolutional (DSC) network on a DSC accelerator, the program code executed by a processor and comprising:
program code to determine, at a first time, a difference between a first throughput associated with a depth-wise convolution (DWC) engine of the DSC accelerator and a second throughput associated with a point-wise convolution (PWC) engine of the DSC accelerator;
program code to selectively activate, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput; and
program code to process, at a third time for each layer of the DSC network, an input via the DSC accelerator based on selectively activating each first PE in the one or more first columns and/or each second PE in the one or more second columns.

14. The non-transitory computer-readable medium of claim 13, in which the first time is a compile time and the third time is a run time.

15. The non-transitory computer-readable medium of claim 13, in which:
each first PE is a dual functional (DF) PE; and
each second PE is one of the DF PE or a PWC PE.

16. The non-transitory computer-readable medium of claim 13, in which:
the DWC engine includes a plurality of window buffers; and
each of the plurality of window buffers reads one or more input feature maps from a respective input channel of a plurality of input channels.

17. The non-transitory computer-readable medium of claim 16, in which:
each window buffer outputs to one or more first PEs; and
each of the one or more first PEs is associated with a different column of the first set of columns.

18. The non-transitory computer-readable medium of claim 13, in which the one or more columns of first PEs and/or the one or more columns of second PEs are selectively activated based on a kernel size, a number of output channels, a first delay compensation in the DWC engine, and/or a second delay compensation in the PWC engine.

19. An apparatus for operating a depth-wise separable convolutional (DSC) network on a DSC accelerator, comprising:
means for determining, at a first time, a difference between a first throughput associated with a depth-wise convolution (DWC) engine of the DSC accelerator and a second throughput associated with a point-wise convolution (PWC) engine of the DSC accelerator;
means for selectively activating, at a second time for each layer of the DSC network, each first processing elements (PEs) in one or more first columns of a first set of columns of first PEs associated with the DWC engine and/or each second PE in one or more second columns of a second set of columns associated with the PWC engine based on the difference between the first throughput and the second throughput; and
means for processing, at a third time for each layer of the DSC network, an input via the DSC accelerator based on selectively activating each first PE in the one or more first columns and/or each second PE in the one or more second columns.

20. The apparatus of claim 19, in which the first time is a compile time and the third time is a run time.

21. The apparatus of claim 19, in which:
each first PE is a dual functional (DF) PE; and
each second PE is one of the DF PE or a PWC PE.

22. The apparatus of claim 19, in which:
the DWC engine includes a plurality of window buffers; and
each of the plurality of window buffers reads one or more input feature maps from a respective input channel of a plurality of input channels.

23. The apparatus of claim 22, in which:
each window buffer outputs to one or more first PEs; and
each of the one or more first PEs is associated with a different column of the first set of columns.

24. The apparatus of claim 19, in which the one or more columns of first PEs and/or the one or more columns of second PEs are selectively activated based on a kernel size, a number of output channels, a first delay compensation in the DWC engine, and/or a second delay compensation in the PWC engine.
